(19) United States
(12) Patent Application Publication
(10) Pub. No.: US 2018/0004823 A1
(43) Pub. Date: Jan. 4, 2018

(54) SYSTEM AND METHOD FOR DATA PROFILE DRIVEN ANALYTICS

(71) Applicant: Automation Anywhere, Inc., San Jose, CA (US)

(72) Inventors: ABHIJIT KAKHANDIKI, SAN JOSE, CA (US); JAYARAMAN BALASUBRAMANIAN, SAN JOSE, CA (US); ABDUL RAZACK RAJAA MOHAMAD, DUBLIN, CA (US); PRATIK THAKOR, FREMONT, CA (US)

(21) Appl. No.: 15/675,180

(22) Filed: Aug. 11, 2017

Related U.S. Application Data
(63) Continuation-in-part of application No. 15/351,615, filed on Nov. 15, 2016.
Application No. 15/351,615 is a continuation-in-part of application No. 14/988,877, filed on Jan. 6, 2016.
Application No. 14/988,877 is a continuation-in-part of application No. 14/939,715, filed on Nov. 12, 2015.
Application No. 14/939,715 is a continuation-in-part of application No. 14/834,773, filed on Aug. 25, 2015.
Application No. 14/834,773 is a continuation-in-part of application No. 12/787,469, filed on May 26, 2010, now Pat. No. 8,504,803.
Application No. 12/787,469 is a continuation-in-part of application No. 13/925,522, filed on Jun. 24, 2013, now Pat. No. 9,462,042.
(60) Provisional application No. 62/409,444, filed on Oct. 18, 2016.
(60) Provisional application No. 62/258,601, filed on Nov. 23, 2015.
(60) Provisional application No. 62/160,655, filed on May 13, 2015.
(60) Provisional application No. 62/130,068, filed on Mar. 9, 2015.

(51) Int. Cl. G06F 17/30

(52) U.S. Cl. CPC G06F 17/30554; G06F 17/30477; G06F 17/3053

(57) ABSTRACT

This invention generally relates to a process, system and computer code for enabling users to create adapters that enable application automation by collecting automation information for purposes of data profiling each source data schema presented for analysis to determine the data types and classify them accordingly (string, number, date); ranking and classifying the data elements by their importance using the data profiling information generated; building individual widgets needed to construct the data dashboard based on the top ranked data elements; auto-generation of visualization dashboards that combine the individual widgets identified; associate the most relevant date filter to perform time-series analysis on the generated dashboard; customization and personalization from the starter dashboard.

### CROSS-REFERENCE TO RELATED APPLICATIONS

This is a continuation-in-part of and claims the priority benefit under 35 U.S.C. 120 for U.S. patent application Ser. No 15/351,615, entitled ROI Based Automation Recommendation and Execution, filed Nov. 15, 2016; and 35 U.S.C. 120 for U.S. patent application Ser. No. 62/409,444, entitled System and Method for Data Profile Driven analytics, filed Oct. 18, 2016; and 35 U.S.C. 120 for U.S. patent application Ser. No 14/988,877, entitled System And Method For Compliance Based Automation, filed Jan. 6, 2016; and 35 U.S.C. 120 for U.S. patent application Ser. No. 62/258,601, entitled ROI Based Automation Recommendation And Execution, filed Nov. 23, 2015; and the priority benefit under 35 U.S.C. 120 for U.S. patent application Ser. No 14/939,715, entitled Artificial Intelligence & Knowledge Based Automation Enhancement, filed, Nov. 12, 2015; and the priority benefit under 35 U.S.C. 120, Ser. No. 62/160,655, entitled System And Method For Compliance Based Automation, filed May 13, 2015; and 35 U.S.C. 120 for U.S. patent application Ser. No. 62/130,068 entitled System And Method For Upgrade Resilient Automation, filed Mar. 9, 2015; and Ser. No. 14/834,773, entitled System And Method For Resilient Automation, filed Aug. 25, 2015; and under 35 U.S.C. 120 for U.S. Pat. No. 9,462,042 entitled System And Method For Enabling Application Discovery By Automation Needs, issued Oct. 4, 2016; and the priority benefit under 35 U.S.C. 120 for U.S. Pat. No. 8,504,803 System and Method For Creating and Executing Portable Software, the entire disclosures of which are hereby incorporated by reference herein.

### FIELD OF THE INVENTION

The present invention relates to information technology software that enables automation processes that tracks data via custom configured bots, whose data are then stored, analyzed, and visually presented.

### BACKGROUND OF THE INVENTION

End users of Web task, legacy applications, Apple (Apple is a registered trade mark of Apple, Inc.) or Windows (Windows is a registered trade mark of Microsoft Corporation) based operating systems create few automated processes, that is, a series of steps that a user desires to execute on a computer (often at a pre-defined time or with a click of a button or a mouse). These software processes could be of any type and for any purpose, e.g., business, IT, scientific, or requirements to validate software behavior, etc. In some instances, the user desires to create a task, such as a bot for tracking and acquiring data, assign properties to the task, and then run the task on a local or a remote computer.

Desirable applications may be the creation of adapters that enable the automatic, periodic, collection of information and presenting that information to a user in a form that is visually helpful. Such systems assist the user to interactively analyze data that may be represented in a dashboard form, to permit the refinement of what may be useful data. In addition to permitting the refinement of what may be useful data and the ability to view it in forms that are constructive to an analysis, it may be instructive to a user that they see the interactions of the various data, such as acquired data and its meaning as relates to certain applications. Such visualization would allow the user to reach better decisions, or employ other applications more efficiently, as implied or derived from data. Traditional analytic visualization tools need data and business experts to manually construct data dashboards that require a deep understanding of the data elements and attributes being presented. These types of efforts are not scalable when one has hundreds of underlying data sources, each with its own distinct schema and data attributes.

U.S. Pat. No. 8,504,803 ('803) entitled System and Method For Creating and Executing Portable Software, incorporated by reference herein, demonstrates the creation of commands having single execution features or as part of a several line operation or one of several commands known as a portable unit that will facilitate the construction of the inventive features of the invention herein. What is needed is a system and method utilizing the principles of the '803 patent and to further enable the automated generation of dashboards, by using data analysis and profiling based techniques.

### SUMMARY OF THE INVENTION

The invention discloses a computerized method for executing the steps including: (1) assembling tasks for collecting data for purposes of displaying a visual comparative, qualitative or quantitative analysis; (2) executing an analytics processor to perform an analysis of the data; (3) marking variables pertinent to the data by choosing from available variables related to the tasks; (4) choosing a data profile for inspecting the data against each variable marked for analytical examination within one or more elements of the task; (5) choosing a rank tab for displaying a distribution of the data against the parameters for an assigned variable; (6) running the tasks through the analytics processor; (7) automatically creating a dashboard for viewing one or more key comparative, qualitative or quantitative indicators, such as one of a mathematical presentation, chart, map or graph; (8) optionally using a data filter for analyzing the data over a data field and displaying the data field on the dashboard.

This disclosure further relates to a computer method for creating a dashboard on a display including the steps of: (1) creating an execution file having one or more tasks having command line arguments executable as widgets by the computer, assembled into an execution file, which includes nested tasks; (2) organizing the nested task related to each task; (3) accounting for all dependencies to insure that files, tasks, and environments for running on the computer are present in the execution file; (4) the step of creating an execution file further including, (a) reading the task file, (b) scanning for event dependencies, and (c) embedding files and links needed for execution of the execution file, (d) storing the dependencies in a dependency file, and (e) accessing a data profiler to profile data attributes related to the line arguments and pertinent to data sources tagged, (f) outputting the data profiler attributes and identifiers to a data rank classifier for a visualization widget generator, whereby one or more individual key performance indicators are programmatically input to a dashboard generator that combines the individual widgets to create a single dashboard associated with the underlying automation task for which the data attributes were associated.

This disclosure further relates to a computer system for creating a dashboard comprising: (1) executable widgets assembled into an execution file, which includes nested tasks; (2) a data elements profiler for profiling data attributes pertinent to a tagged data source for which one of a comparative, qualitative or quantitative analysis is desired; (3) a data rank classifier for inspecting the results from the data profiler and classifying numeric attributes based on a preselected parameter; (4) a visualization widget generator for generating a key performance indicator whereby one or more widgets selected attributes, is identified by a data rank classifier; (5) A dashboard generator for combining widgets generated by the visualization widget generator, for creating a dashboard associated with the underlying automation task for which the data attributes are associated; (6) a date filter associator in association with each of the widgets that form that part of the dashboard generated.

### BRIEF DESCRIPTION OF THE DRAWINGS

FIG. 1 shows a computer system for data profiling and generating a dashboard to make information more readily useable in accordance with an embodiment of the present invention;

FIG. 2 shows the main steps for data profiling and generating a dashboard to make information more readily useable in accordance with an embodiment of the present invention;

FIG. 3 shows the modules, their inputs and outputs for creating one or more application files, in accordance with an embodiment of the present invention;

FIG. 4 shows a screen of an application for acquiring information from a data source for profiling, in accordance with an embodiment of the present invention;

FIG. 5 shows a shows a screen of an application for acquiring information from a data source for profiling, in accordance with an embodiment of the present invention;

FIG. 6 shows a screen of a dashboard that data profiles in accordance with an embodiment of the present invention;

FIG. 7 shows a screen of a dashboard, where there has been expansion of a profile in accordance with an embodiment of the present invention.

### DESCRIPTION OF PREFERRED EMBODIMENT

The present invention will now be described more fully with reference to the accompanying drawings, in which the preferred embodiments of the invention are shown. This invention may be embodied in many different forms and should not be construed as limited to the embodiments set forth. Rather, these embodiments are provided so that this disclosure will be thorough and complete, and will fully convey the scope of the invention to those skilled in the art. Like numbers refer to like elements throughout. In what follows, application software refers to all the computer software that causes a computer to perform useful tasks beyond the running of the computer itself.

The disclosure more specifically relates to software, which manages and integrates a computer's capabilities, such as the generation of widgets and adapters to enable application automation that can be leveraged by various automation engines, including such technology as offered at Automation Anywhere (found at www.automationanywhere.com).

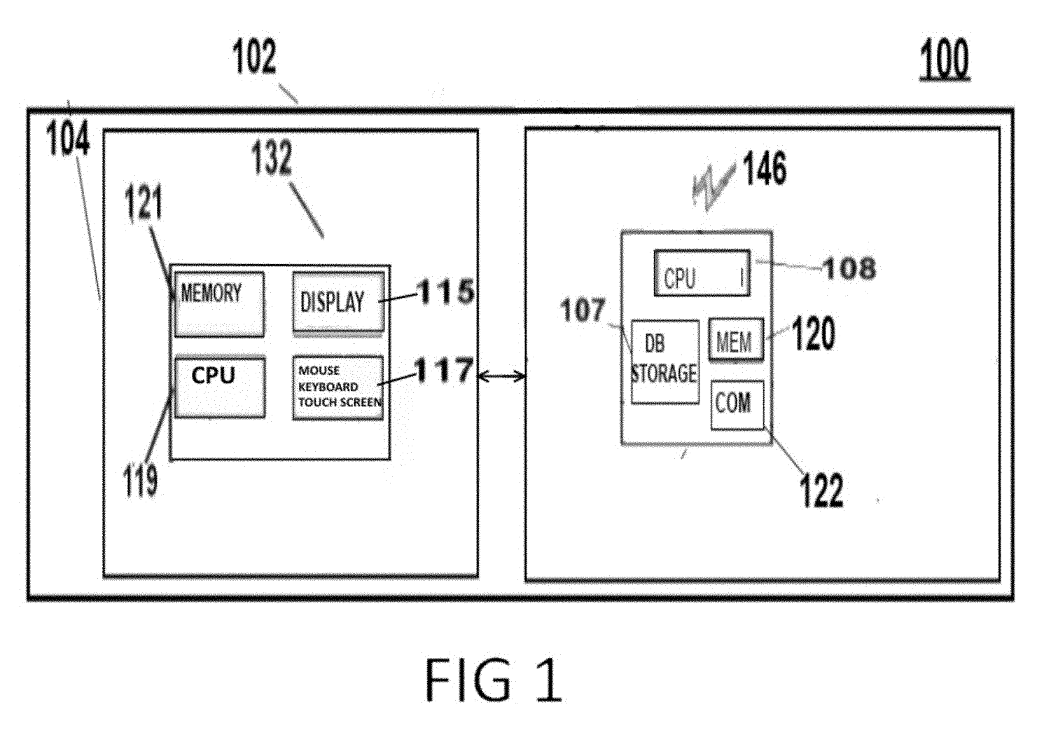

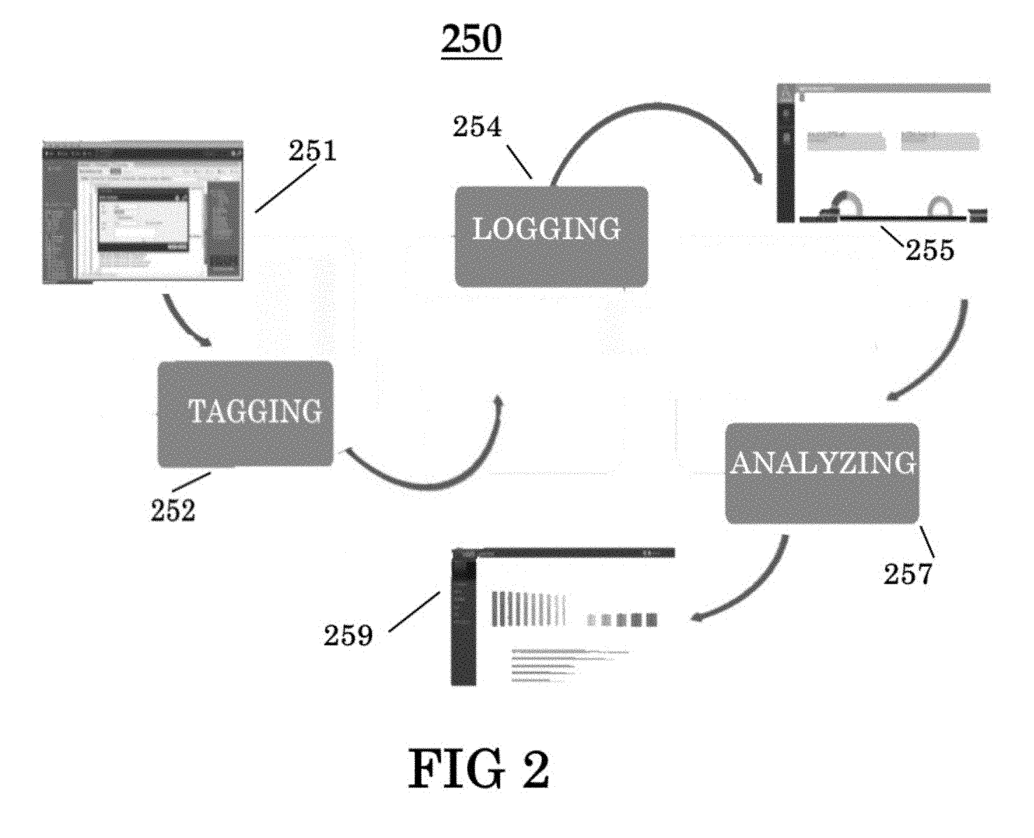

FIG. 1 represents a computer system 100, which operates a process 250 (see, FIG. 2), where a user at an origin can create software processes, in one computer environment that can be used in the self contained computer environment, such as computer environment 102, containing applications ported to one or more remotely situated computers for obtaining a resource or data as needed to accomplish a task such as by way of example and not limitation, tagging business entities, such as customer identification, product identification, and the source of the data being processed by a bot or widget; logging the tagged data for every instance or execution of a bot; collecting the data and analyzing the data, using mathematical and logical algorithms. System 100 includes at least one user computer 104 that contains a subsystem 132 having at least one central processing unit (CPU) 119, which typically is the processor for an operating system and an application resident in memory 121 that contains display 115 that employs a graphical user interface (GUI) and an input device 117 in addition to having the facility to access other computers and databases, such as database 107. CPU 108 and CPU 119 include processors, and associated memories, 121 and 120 respectively, and contain one or more conventional microprocessors and one or more supplementary co-processors such as math co-processors. In CPU 108 at least one such processor may be in communication with a communication module 122 that transmits data over a port through which the communication module 122 communicates with other devices such as other servers, databases and user terminals or devices and the Internet 146. The communication port may include multiple communication channels for simultaneous communication with, for example, other processors, servers or client terminals.

The data storage device 107 may store, for example, (i) a program, (e.g., computer program code and/or a computer program product), for creating, executing and porting the software, as more fully described in FIG. 2, to direct the processor in accordance with the present invention, and particularly in accordance with the processes described in detail hereinafter with regard to the creating, executing and porting the widgets of bots, tagging, logging and analyzing the data, to achieve the novelty of the invention; (ii) a database adapted to store information that may be utilized to store information required by the program for creating, executing and porting the bot, tagging, logging and analyzing the data, to achieve the novelty of the invention. The program for creating, executing and porting the widgets or bots, tagging, logging and analyzing the data, to achieve the novelty of the invention may be stored, for example, in a compressed, an uncompiled and/or an encrypted format, and may include computer program code. The instructions of the program, included user generated macros that may include instructions to record and playback executable programs may be read into a main memory of the processor from a computer-readable medium other than the data storage device, such as from a ROM or from a RAM. While execution of sequences of instructions in the program causes the processor to perform the process steps described herein, hard-wired circuitry may be used in place of, or in combination with, software instructions for implementation of the processes of the present invention. Thus, embodiments of the present invention are not limited to any specific combination of hardware and software.

The term “computer-readable medium” as used herein refers to any medium that provides or participates in providing instructions to the processor of the computing device (or any other processor of a device described herein) for execution and more particularly for creating, executing and porting the bot, tagging, logging and analyzing the data, to achieve the novelty of the invention. Such a medium may take many forms, including but not limited to, non-volatile media, volatile media, and transmission media. Non-volatile media include, by way of example, optical or magnetic disks, such as memory. Volatile media may include dynamic random access memory (DRAM), which typically constitutes the main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM or EEPROM (electronically erasable programmable read-only memory), a FLASH-EEPROM, any other memory chip or cartridge, a carrier wave as described hereinafter, or any other medium from which a computer can read.

Various forms of computer readable media may be involved in carrying one or more sequences of one or more instructions to the processor (or any other processor of a device described herein) for creating, executing and porting the bot, tagging, logging and analyzing the data. For example, the instructions may initially be borne on a magnetic disk of a remote computer. The remote computer can load the instructions into its dynamic memory and send the instructions over an Ethernet connection, cable line, or even telephone line using a modem. A communications device local to a computing device (or, e.g., a server, such as communication module 122) can receive the data on the respective communications line and place the data on a system bus for the processor. The instructions received by main memory may optionally be stored in memory either before or after execution by the processor. In addition, instructions may be received via communication module 122 and associated port as electrical, electromagnetic or optical signals, which are exemplary forms of wireless communications or data streams.

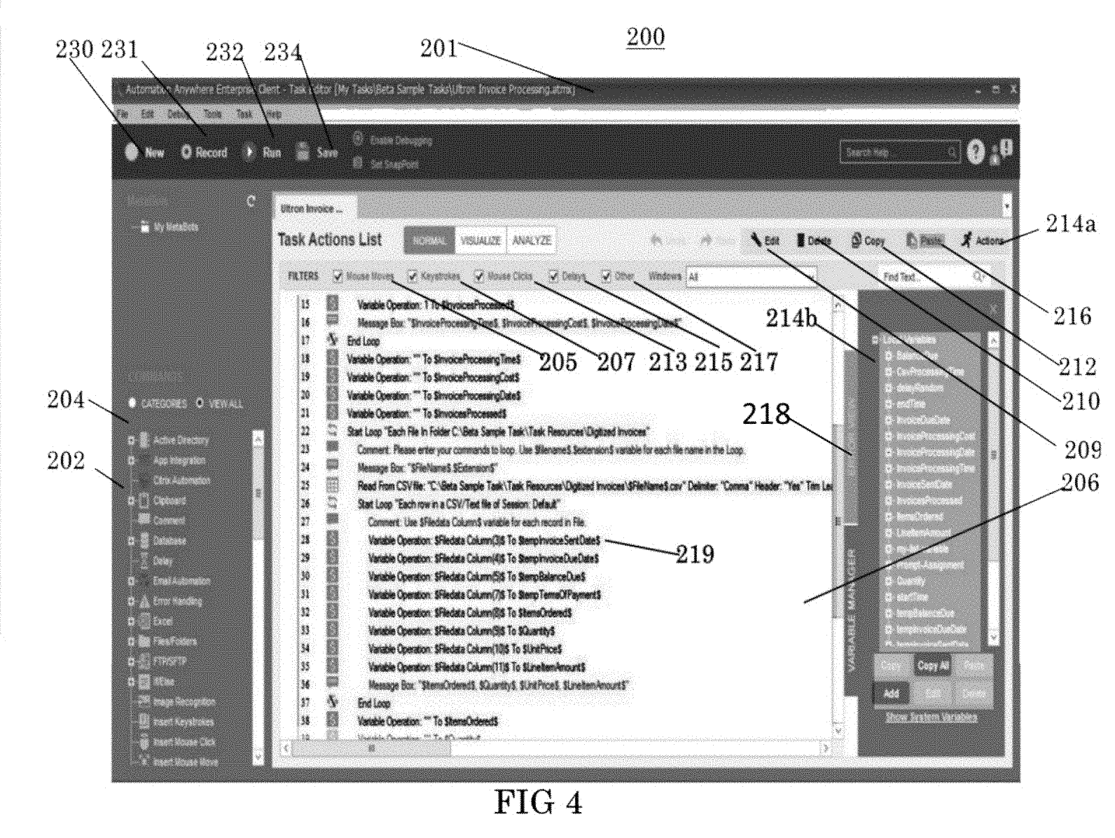

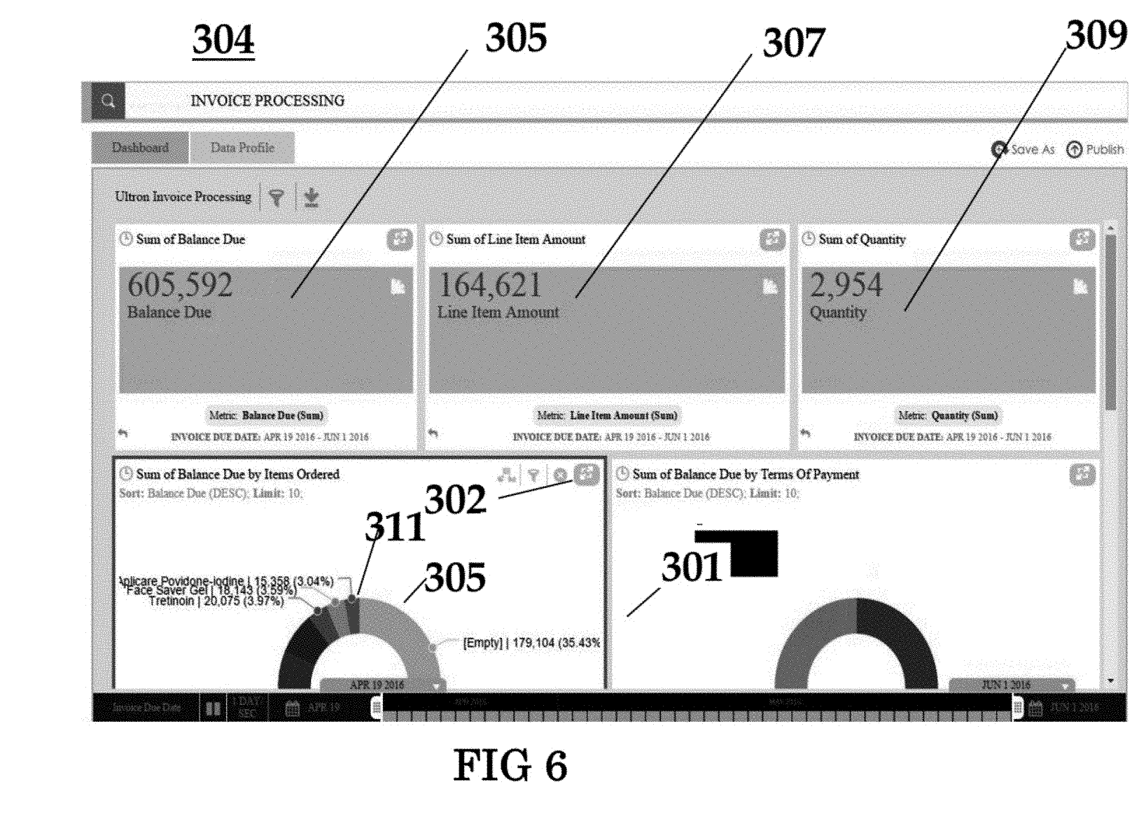

FIG. 2 discloses a computerized process 250 for creating an analytical presentation of diverse information. The method includes using a browser having therein a program 251 for extracting data relevant to a particular analysis. In step 1 a user engages in tagging 252, each source data schema, by way of example, data about a particular business entity or information related thereto, such as products, goods, services, and their attributes (quantity, quality, amount of sales, cost of goods, etc.). Additionally tagging may be used to point to or identify data to be subsequently retrieved by a system bot. The bot thereafter engages in step 2 of the process by logging 254, in real time or in other instances at a specified time chosen by a system timer, the data that had been identified during step 2, i.e., tagging 252. The information that is logged in step 2 is displayed in a browser (FIG. 4). In step 3 the data is processed, as described below, to yield visualizations of charts, graphs and other selected depictions relevant to the analysis that a user desires to perform. An analyzing 257 step 4, allows a user to analyze the information in the data dashboard 255 (FIG. 6).

The data profiling of each data source schema is presented for analysis as data types and classified accordingly, as by way of example strings, numbers, and such distinguishing characteristics as date, time, place or condition of occurrence. The process 250 also includes ranking and classifying the data elements according to salience of the information that is being generated. The process allows building individual bots or widgets needed to retrieve data from multiple sources, that then allows automatic construction of the data into a dashboard 255 visualization, based on by way of example, a ranking of data elements, predefined by the user, based on user generated algorithms, or other artificial intelligent processes. As indicated in step 3 an auto-generation of a visualization dashboard 255 combines the individual widget generated data, by associating the relevant data filters to perform such visualizations as charts, graphs (e.g., time-series analysis) and maps on the dashboard 255. The process 250 also allows for the customization and personalization of the dashboard 255.

The invention further discloses a computerized method that embodies process 250, for executing the steps including: (1) assembling tasks for collecting diverse information for purposes of displaying a visual comparative, qualitative or quantitative analysis; (2) executing an analytics processor to perform an analysis of the information; (3) marking variables pertinent to the data analysis by choosing from available variables related to the tasks; (4) choosing a data profile for inspecting the data against each variable marked for analytical examination within one or more elements of the task; (5) choosing a rank tab for inspecting a distribution of the data against the parameters for an assigned variable; (6) running the tasks through the analytics processor; (7) automatically creating a dashboard for reviewing one or more key comparative, qualitative or quantitative indicators, such as one of a mathematical (e.g., statistical presentation or graphical timeline), chart, map or graph; (8) optionally using a data filter for analyzing the data over a data field and displaying the data field on the dashboard.

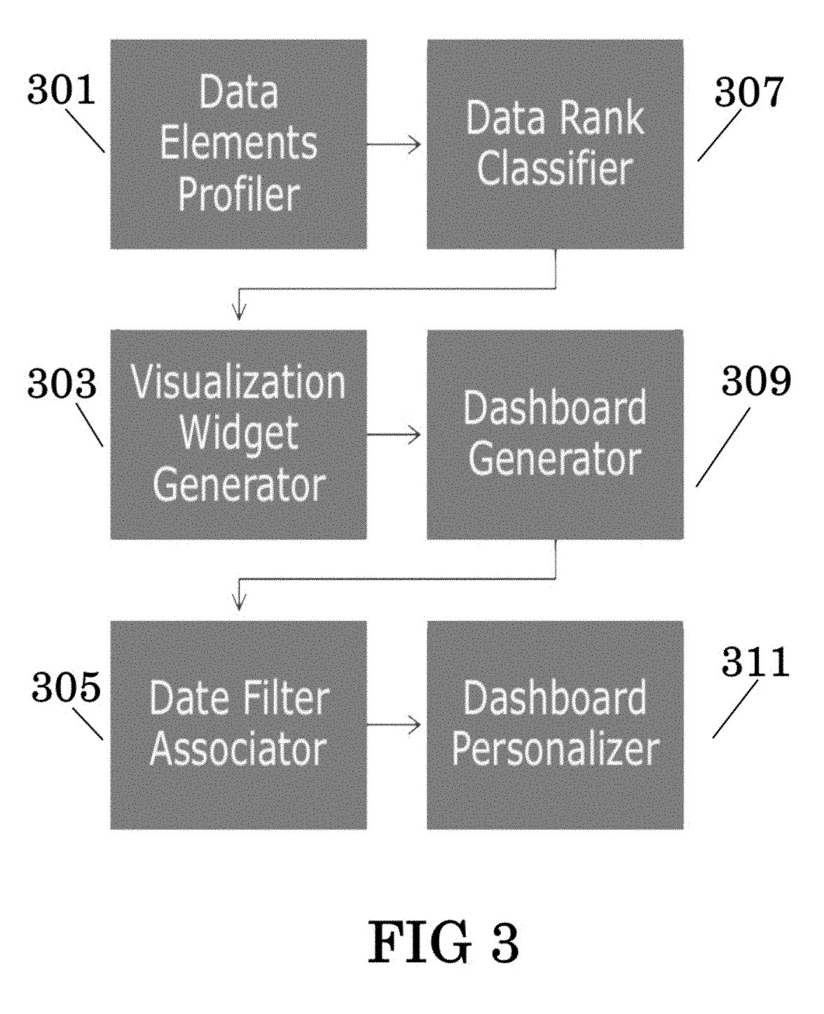

Referring now to FIG. 3, a set of modules 301-307 comprise anon limiting embodiment of the invention for carrying out the process 250, and specifically as pertains to the step 257 (see, FIG. 2) analysis and display step 259 (see, FIG. 2) presentation of the information retrieved. These modules include the following analysis and presentation functions:

A data profiler 301 profiles the various data attributes pertinent to a data source tagged 252 (FIG. 2) and identifies data types (by way of example and not limitation, string, numeric, date) and for which one of a comparative, qualitative or quantitative analysis is desired, as by way of example a statistical distributions such as MIN, MAX, SUM, AVG and DISTINCT counts. The data profiler outputs the profile attributes and the identifiers to a data rank classifier 307.

The data rank classifier 307 inspects the results from the data elements profiler 301 and classifies the ‘n’ most valuable numeric attributes based on a preselected parameter, such as by way of example, a data distribution range (MAX-MIN). It then ranks this list based on an appropriate measure, such as by way of example, a SUM of the data values for each attribute. Thereafter the data rank classifier 307 determines a set of the ranks, such as the top n, where n is a number, such as 3, for a visualization widget generator 303.

The visualization widget generator 303 generates a individual key performance indicator (KPI), such as a pie chart, donut chart or time-series bar chart, whereby one or more widgets select attributes, such as a numeric data attribute, as identified by the data rank classifier 307. For example, a time-series bar chart, may depict the top 2 KPIs, which are then identified and plotted against by way of example, a date or time attribute that is identified based on the date or time having an attribute with a highest distinct value count. By way of another example, a donut chart may include the top KPI identified as plotted over 2 string type attributes, where a row count sum for the top 10 values as a percent (%) of total row count is highest.

A dashboard generator 309 combines all the individual widgets generated by a visualization widget generator 303, and creates a single dashboard that is associated with the underlying automation task for which the data attributes were associated.

A date filter associator 305 is a common data filter in association with each of the widgets that form that part of the dashboard generated, which is selected from the list of attributes based on certain parameters as, by way of example, the highest DISTINCT value count.

After the dashboard 259 (see, FIG. 2) is generated by the dashboard generator 309, a dashboard personalizer 311 enables a level of personalization, where the labels of the individual widgets can be personalized, by way of example, new widgets added, etc.

With further reference to FIG. 1, FIG. 2, and FIG. 3, and by way of example and not limitation, a user of the system 100 (FIG. 1) may desire to create, load and execute the process 250 instantiated as a task to be run at various times or repetitively on local computer 104 to achieve the foregoing objects. In a browser, viewed by the user in display 115, process 250 will permit the user to insert commands having single execution features or as part of a several line operation, or one of several commands that may operate as part of a larger loop or nested loop that will have the effect of achieving an outcome as described in connection with FIG. 2, FIG. 3. As by way of example a user would achieve the objects of the invention by the following series of operations: (1) locate candidates for tagging 252 (“id”); (2) determine if a unique control found and control type match; (3) eliminate candidates not relevant to the tagging 252 process; (4) optionally assign weights to compute match probability; (5) determine attribute differences for each candidate if required.

More specifically, the disclosure herein further relates to a computer method for creating a dashboard on a display including the steps of: creating an execution file having one or more tasks having command line arguments executable as widgets by the computer, assembled into an execution file, which includes nested tasks, organizing the nested task related to each task and accounting for all dependencies to insure that files, tasks, and environments for running on the computer are present in the execution file, said step of creating an execution file further including, reading the task file, scanning for event dependencies and embedding files and links needed for execution of the execution file, storing the dependencies in a dependency file, and accessing a data profiler 301 to profile data attributes related to line arguments and pertinent to data sources tagged, the data profiler outputting the profile attributes and identifiers to the data rank classifier 307 for the visualization widget generator 303, that generates one or more individual key performance indicators to be input to a dashboard generator 309 that combines the individual widgets generated by the visualization widget generator 303, to create a single dashboard that is associated with the underlying automation task for which the data attributes were associated. A data filter associator 305 functions as a common data filter to allows the user to separate widgets that form that part of the dashboard generated into distinct categories.

More particularly with reference to FIG. 4, a suitable computer program code will allow the tagging and creation of the tasks 200 that provides for performing process 250. A browser having a task editor 201, assists in the creation a new task 219, which will be incorporated into the execution file, as hereinbefore described, using point and click functionality as will be further described below, and as appropriate, to record key strokes defining a new task, to run 232 the new task 219 and to edit 209 the new task, within the context of a task action list denoted by lines 15 through 38 by way of illustration.

Upon execution of the new task 219, the data elements profiler 301 (FIG. 3), coded to extract various data attributes within a data source (related to the new task) and to identify data types (string, numeric, date) related to one of comparative, qualitative or quantitative analysis, as by way of example, statistical distributions such as MIN, MAX, SUM, AVG and DISTINCT counts, provides the information required by the data rank classifier 307 (FIG. 3). The computer program code required to create a data elements profiler 301 (FIG. 3) with the above functionality (and the other functions described herein) can be developed by a person of ordinary skill in the art of programming, and is not described in detail herein.

As shown in FIG. 4, suitable computer program code is provided for performing numerous functions such as displaying a task editor 201 in the browser, and such as creating a new task 230, to be ported to another computer, or to be run on the same computer as where the task editor 201 is resident. The task editor 201 includes drop and drag commands, which all various tasks to be imported into a task action list, and as appropriate, to edit 209, delete 210, copy 212 and paste 216 commands, within the context of the task action list 219. The computer program code required to implement the above functions (and the other functions described herein) can be developed by a person of ordinary skill in the art of programming, and is not described in detail herein.

Task editor 201 contains three adjunct windows, a task action window 206, a command window 204 and an action window 214b. The task editor 201 also includes commands that are inserted into the task action window 206. For each of the commands 202, added as tasks, the system 100 permits inserting new actions or keystrokes 207, removing/adding mouse moves 205, mouse clicks 213, delays 215 and optimizing tasks, and creating new tasks.

More particularly with reference to FIG. 4, a suitable computer program code may be provided for performing numerous functions such as displaying a the tasks 200 in the browser on display 115 (FIG. 1), to create a new task using point and click functionality as appropriate, and to record 231 key strokes defining the new task, to run 232 the new task 219 and to edit 212 the new task, within the context of a task action list 15 through 38 by way of example. The task action list 217 shows numerous tasks in the new task 219 that for illustration have been previously created. The computer program code required to create a browser with the above functions (and the other functions described herein) can be developed by a person of ordinary skill in the art of programming, and is not described in detail herein.

Referring again to FIG. 4, an action 214a permits viewing and editing enabled features. Features may include: edit 209 keystroke actions; duplicating an action below the marked action; undoing and redoing an action; converting to variable; converting a keystroke to a variable; converting to prompt; converting a keystroke to a prompt message; inserting an ‘If condition’; insert ‘If condition’ for a selected block of task actions; insert error handling; insert error handling for a selected block of task actions; changing window title; setting a window title to multiple window titles; running from ‘This Step’; running the task from a selected action onwards; enabling an action; disabling an action; moving up and moving down an action. In addition a user may record mouse moves 207, mouse clicks 213, control or delay the execution of tasks 215, and other features 217 that may exist from time to time. Those persons of ordinary skill in the art of programming will appreciate the forgoing list of actions and how they are utilized in connection with building a task list as described.

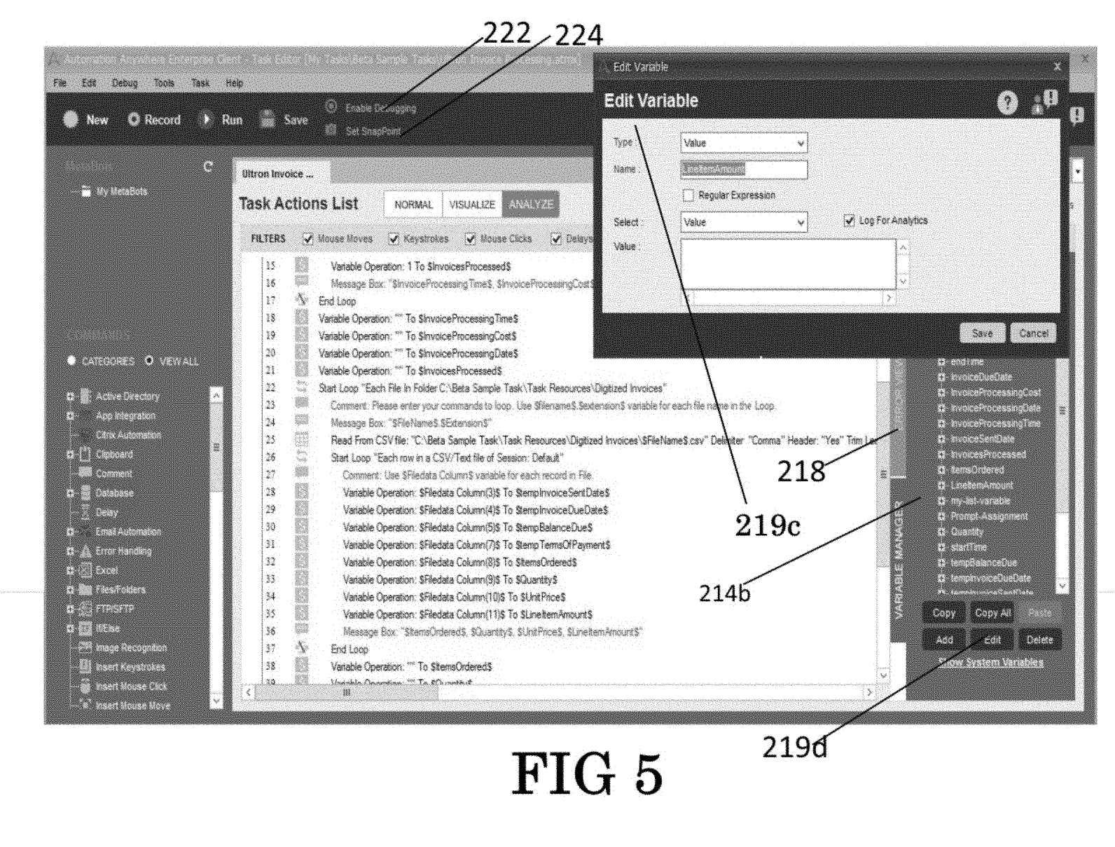

Turning to FIG. 4 and FIG. 5, the variable manager window 214b allows for the insertion of the data from such items as by way of example, invoices and inventory lists. The browser includes an error view 218, and features, such as editing 219d that enables a drop down window 219c, as well as an enable debugging 222 and set snap point 224 function.

When the automation process is executed, the data elements marked for analytics logging 254 (FIG. 2) are logged and stored into an analytics database, such as database 107 (FIG. 1) for that particular automation run. Upon click of the ‘ANALYZE’ button, the data logged is processed through the data elements profiler 301, data rank classifier 307, visualization widget generator 303, dashboard generator 309, date filter associator 305, and auto generate the dashboard 255, as shown in FIG. 2.

Dashboard 255 (FIG. 2) may be customized for creating a visualization of the significance of the information based on such presentations as charts, graphs and other two-dimensional depictions of data relationships, e.g., tables, Venn diagrams, and maps. By way of example the data may be compiled into such information as contained in an invoice processing 304. Such information typically by way of example is Balance Due, 305, Line Item Amount 307 and Quantity 309. Other information may be found in the form of a donut chart 305, by way of example, which segments various contributions to the whole as shown by segment 311.

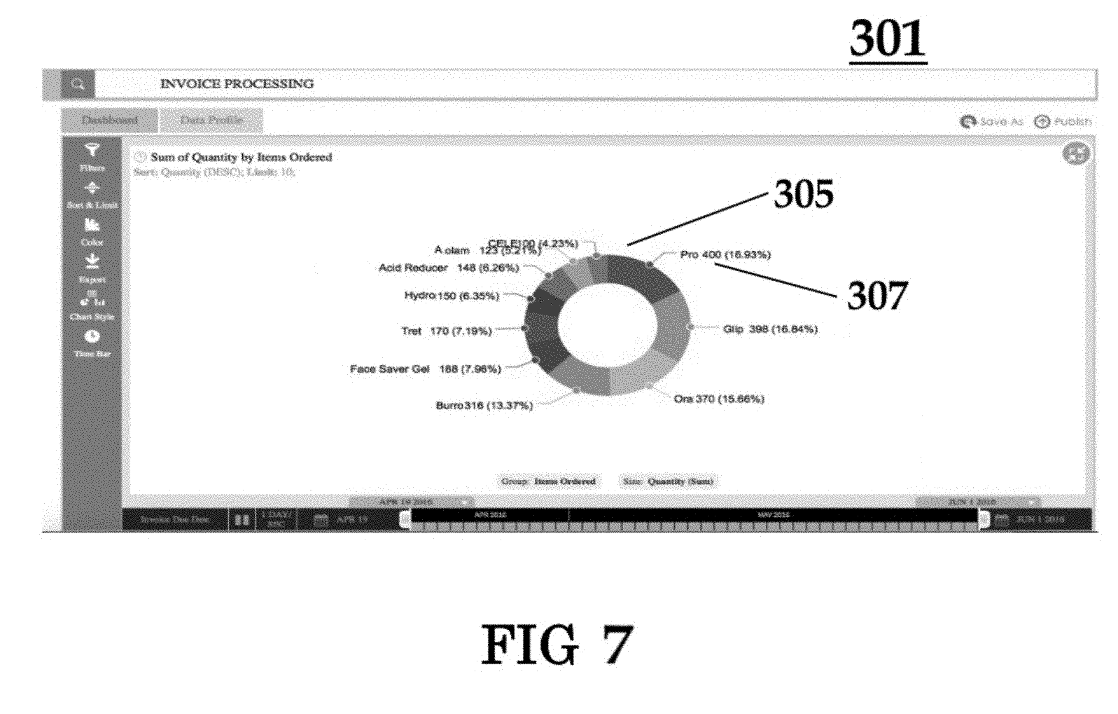

Individual elements of data found inside, by way of example illustrated in FIG. 6, as would appear in an invoice, such as Balance Due 305, Line Item Amount 307 and Quantity 309, which are marked for analytics logging 254 as illustrated (FIG. 2). In FIG. 6, an expansion of each widget producing information, within the dashboard, is achieved by clicking on the corner (see, FIG. 6, 302) of the section of widget 301 to highlight the representation of the data as illustrated in FIG. 7. FIG. 7 further shows the ability to interactively analyze the data by clicking on Group or Size to choose any other metric to plot e.g., size, 307, or analyze the same metric by another attribute, e.g., group.

The foregoing invention has been described with reference to the above embodiments, however additional modifications and changes can be made without departing from the spirit of the invention.

We claim:

1. A computerized method for creating a dashboard on a display comprising the steps: (1) assembling tasks executable as widgets by a computer, assembled into an execution file, which includes nested tasks for collecting data for purposes of displaying a visual comparative, qualitative or quantitative analysis; (2) executing an analytics processor to perform an analysis of the data; (3) marking variables in the data by choosing from available variables related to the tasks; (4) choosing a data profile for inspecting the data against each variable marked for analytical examination within one or more elements of the task; (5) choosing a rank tab for displaying a distribution of the data against parameters for the assigned variable; (6) automatically running the tasks through the analytics processor; (7) automatically creating a dashboard for viewing the one or more visual comparative, qualitative or quantitative indicators, such as one of a mathematical presentation, chart, map or graph; (8) optionally using a data filter for analyzing the data over a data field and displaying the data field on the dashboard.

2. A computer method for creating a dashboard on a display comprising the steps of: (1) creating an execution file having one or more tasks having command line arguments executable as widgets by a computer, assembled into an execution file, which includes nested tasks; (2) organizing the nested task related to each task; (3) accounting for all dependencies to insure that files, tasks, and environments for running on the computer are present in the execution file; (4) the step of creating an execution file further including the steps of: (a) reading the task file, (b) scanning for event dependencies, and (c) embedding files and links needed for execution of the execution file, (d) storing the dependencies in a dependency file, and (e) accessing a data profiler to profile data attributes related to line arguments and pertinent to data sources tagged, (f) outputting the data profiler attributes and identifiers to a data rank classifier for a visualization widget generator, whereby one or more individual key performance indicators are input to a dashboard generator that combines the one or more individual widgets, to create a single dashboard associated with the underlying automation task, for which the data attributes are associated.

3. The method of claim 2, further including assembling tasks for collecting data for purposes of displaying a visual comparative, qualitative or quantitative analysis.

4. The method of claim 2, further including executing an analytics processor to perform an analysis of the data.

5. The method of claim 2, further including marking variables pertinent to the data by choosing from available the variables related to the tasks.

6. The method of claim 2, further including choosing a data profile for inspecting the data against each variable marked for analytical examination within one or more elements of the task.

7. The method of claim 2, further including choosing a rank tab for displaying a distribution of the data against parameters for an assigned variable.

8. The method of claim 2, further including running the tasks through the analytics processor.

9. The method of claim 2, further including creating a dashboard for viewing one or more comparative, qualitative or quantitative indicators, such as one of a mathematical presentation, chart, map or graph.

10. The method of claim 2, further including optionally using a data filter for analyzing the data over a data field and displaying the data field on the dashboard.

11. A non-transitory computer-readable medium having stored thereon computer-readable instructions for creating an execution file having one or more tasks having command line arguments executable as widgets by the computer, assembled into an execution file, which includes nested tasks; (2) organizing the nested task related to each task; (3) accounting for all dependencies to insure that files, tasks, and environments for running on the computer are present in the execution file; (4) the step of creating the execution file further including: (a) reading the task file, (b) scanning for event dependencies, and (c) embedding files and links needed for execution of the execution file, (d) storing the dependencies in a dependency file, and (e) accessing a data profiler to profile data attributes related to line arguments and pertinent to data sources tagged, (f) outputting the data profiler attributes and identifiers to a data rank classifier for a visualization widget generator, whereby one or more individual key performance indicators are input to a dashboard generator that combines the individual widgets to create a single dashboard associated with the underlying automation task, for which the data attributes were associated.

12. A computer system for creating a dashboard comprising: (1) executable widgets assembled into an execution file, which includes nested tasks; (2) a data profiler for profiling data attributes pertinent to a tagged data source for which one of a comparative, qualitative or quantitative analysis is desired; (3) a data rank classifier for inspecting the results from the data profiler and classifying numeric attributes based on a preselected parameter; (4) a visualization widget generator for generating a key performance indicator whereby one or more widgets selected attributes, is identified by a data rank classifier; (5) A dashboard generator for combining widgets generated by the visualization widget generator, for automatically creating a dashboard; (6) a date filter associator.

13. The system of claim 12, wherein the data profiler identifies data types by one of string, numeric, date.

14. The system of claim 12, wherein the data profiler identifies data types for utilization in making one of a comparative, qualitative or quantitative analysis.

15. The system of claim 12, wherein the data profiler identifies utilizes one of a statistical distributions comprised of MIN, MAX, SUM, AVG and DISTINCT counts.

16. The system of claim 12, wherein the data profiler outputs the profile attributes and the identifiers to the data rank classifier.

17. The system of claim 12, wherein the data rank classifier inspects the results from the data elements profiler and classifies the ‘n’ most valuable numeric attributes based on a preselected parameter.
